(19) United States
(12) Patent Application Publication
(10) Pub. No.: US 2020/0063407 A1
(43) Pub. Date: Feb. 27, 2020

(54) PULL-OUT FAUCET WITH MAGNETIC DOCKING SYSTEM

(71) Applicant: XIAMEN LOTA INTERNATIONAL CO., LTD., Xiamen (CN)

(72) Inventors: Chuanbao Zhu, Xiamen (CN); Liming Ye, Xiamen (CN); Jianping Zhou, Xiamen (CN); Jijin Peng, Xiamen (CN)

(21) Appl. No.: 16/546,271

(22) Filed: Aug. 20, 2019

(30) Foreign Application Priority Data
Aug. 20, 2018 (CN) 201821338327.X

(51) Int. Cl. E03C 1/04; B05B 1/18; B05B 15/65

(52) U.S. Cl. CPC E03C 1/0404; E03C 2001/0415; B05B 15/65; B05B 1/185

(57) ABSTRACT

A pull-down faucet includes a spout and a water hose movable within the spout. A spray hose connector is attached to the discharge end of the water hose. A sprayhead is in fluid communication with the spray hose connector and the water hose, and is movable between a docked position adjacent the discharge end of the spout, to an undocked position away from the spout. A magnet is secured to the interior of the spray hose connector, and a metallic element is secured near the discharge end of the spout.

### CROSS-REFERENCE TO RELATED APPLICATIONS

This application claims priority to Chinese Patent App. No. 201821338327.X, filed Aug. 20, 2018, the disclosure of which is incorporated herein by reference in its entirety.

### TECHNICAL FIELD

The present disclosure is directed to a pull-out faucet with a magnetic docking system.

### BACKGROUND

The present disclosure relates to a pull-out faucet with a magnetic docking system. More specifically, the present disclosure relates to a novel structure for releasably coupling a pull-out sprayhead to a faucet body.

Kitchen faucets and other faucets with pull-out sprayheads are known in the art. These pull-out sprayheads offer the user significant flexibility. Particularly, when the user pulls the sprayhead away from the faucet and into an “undocked” position, the user may direct water from the undocked sprayhead to a particular part of a sink, or even direct water from the sprayhead to regions remote from the sink, such as to a countertop.

Some current faucets with pull-out sprayheads have certain deficiencies. As but one example, after a certain period of time, the docking systems of these faucets provide inadequate force to move the sprayheads from their undocked positions to a fully docked position. A sprayhead/faucet combination that is not fully docked is not aesthetically appealing to either homeowners or their guests.

The known prior art pull-out faucets rely upon various means to retain the sprayhead within the spout, or to return a sprayhead to its docked position. These can include counterweights, magnets, compression springs, and others.

There is a need for an improved docking system that does not have the limitations or disadvantages of the prior docking systems.

### SUMMARY

One embodiment of a faucet in accordance with the present disclosure includes a spout; a water hose with an inlet end and a discharge end, the water hose being disposed within, and movable within, that spout; a spray hose connector attached to the discharge end of the water hose; and a sprayhead that is in fluid communication with the water hose and the spray hose connector, and releasably attached to the water discharge end of the faucet.

The sprayhead is movable from a docked position, where it is secured to the discharge end of the spout; to an undocked position, where it is moved away from that same discharge end of the spout.

Secured to the interior of the spray hose connector is a magnet. This magnet may be of any shape, but is preferably of a hollow, frusto-conical shape, so that it essentially circumscribes the interior of the spray hose connector and permits for the passage of water through the magnet.

The magnet may be held in place within the spray hose connector by any suitable means.

As noted above, when the sprayhead is in its docked position, it is positioned adjacent the discharge end of the spout of the faucet. Also positioned near the discharge end of the spout of the faucet is a metallic element.

This metallic element may preferably have a ring shape. The metallic element can be made of any material that is magnetically attractive. In one preferred embodiment, the metallic element is made of stainless steel, such as SUS 430 stainless steel.

The metallic element is preferably fixed to the inside of the spout with a holder. The holder includes a sleeve for insertion into the discharge end of the spout and a clip coupled to the sleeve for engagement with the spout to fix the holder relative to the spout. The metallic element is coupled to the sleeve.

### BRIEF DESCRIPTION OF THE DRAWINGS

FIG. 1 is a perspective view of a pull-out faucet in accordance with the present disclosure, with the sprayhead in its docked position, and including only the portions of the faucet normally mounted above the deck of a kitchen or bathroom counter.

FIG. 2 is an exploded view of the pull-out faucet of FIG. 1, but with the sprayhead in its undocked position, and further including the components of the pull-out faucet that are normally mounted below the deck of the counter.

FIG. 3 is a perspective view of the above- and below-deck components of the pull-out faucet of FIG. 2 in their assembled configuration.

FIG. 4 is a sectional view of the spout portion of the faucet, but without the sprayhead.

FIG. 5 is a perspective view of the spout portion of the faucet of FIG. 4, but further including the water hose and spray hose connector partially removed from the discharge end of the spout; and with the sprayhead separated from the water hose and spray hose connector.

FIG. 6 is an enlarged, sectional view of the sprayhead, spray hose connector, and water hose of FIGS. 1 and 2, in the docked position.

FIG. 7 is an enlarged, sectional view of the sprayhead, spray hose connector, and water hose of FIGS. 1 and 2, in their undocked position.

FIG. 8 is a perspective, partially sectional view of the spray hose connector and spray hose of FIG. 7.

FIG. 9 is an enlarged, sectional view of the spray hose connector of FIG. 8.

FIG. 10 is a frontal view of a machined joint piece used in connection with the spray hose connector of FIG. 9.

FIG. 11 is a front, sectional view of the magnet used in connection with the spray hose connector of FIG. 9.

FIG. 12 is a sectional view of the spray hose connector assembled with the machined joint piece and the magnet.

FIGS. 13-16 show additional steps in connection with the assembly of the spray hose.

FIGS. 17-21 are sectional views of another embodiment of a pull-out faucet in accordance with the present disclosure.

FIG. 22 is a perspective view of another embodiment of a pull-out faucet in accordance with the present disclosure.

FIG. 23 is an exploded view of the pull-out faucet of FIG. 22.

FIG. 24 is a side elevation view of the pull-out faucet of FIG. 22 with portions broken away to show the magnetic docking system.

FIG. 25 is an enlarged view of the pull-out faucet of FIG. 24.

FIG. 26 is an exploded view of the pull-out faucet of FIG. 25.

### DETAILED DESCRIPTION

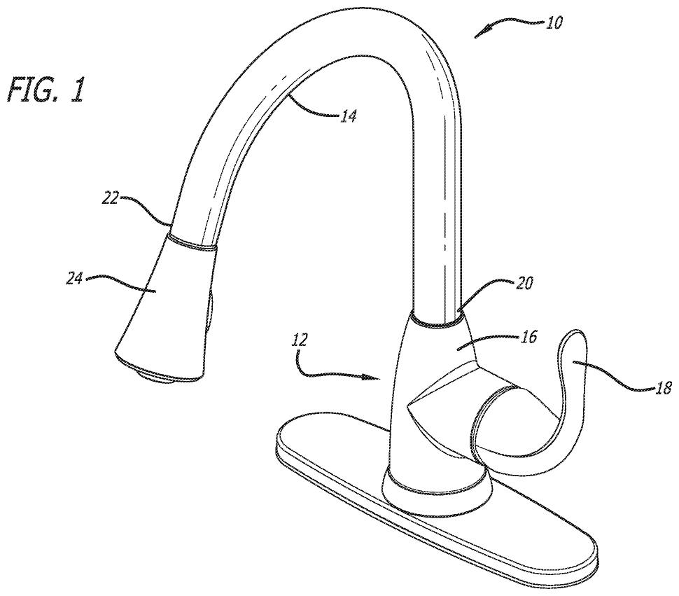

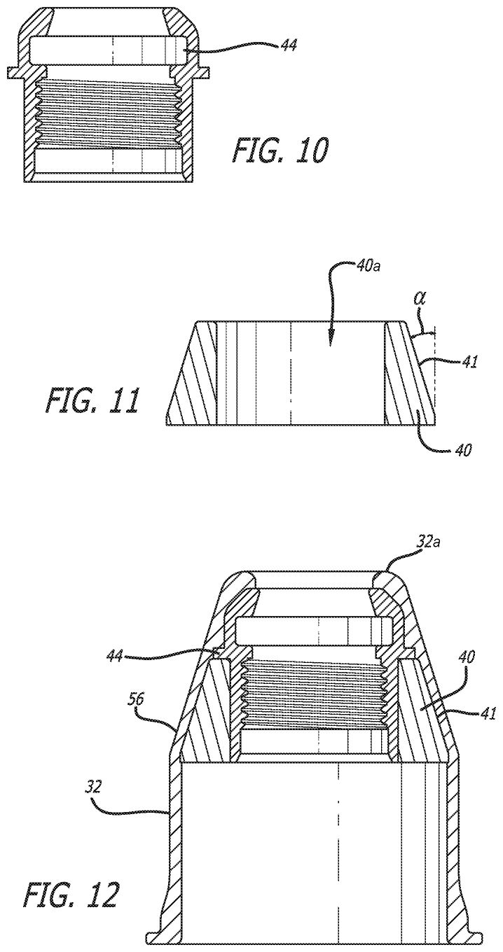

One embodiment of a faucet 10 in accordance with the present disclosure is shown in FIGS. 1-16, including the complete faucet 10 shown in FIGS. 1-3. The faucet 10 includes a body 12 and a spout 14. The body 12 includes a base portion 16 and a handle 18 for regulating the amount of water that passes through the faucet 10. It will be understood, however, that a handle 18 is not necessarily required, and that motion detecting means and other means may be used for regulating the flow of water from the faucet 10.

In this embodiment, the spout 14 has a generally curved shape, and two distal ends. The inlet end 20 of the spout 14 is positioned near the base portion 16. Water from the water source enters the spout 14 near the inlet end 20 of the spout 14. The discharge end 22 of the spout 14 is positioned near the sprayhead 24. Water from the water source exits the spout 14 near the discharge end 22 of the spout 14.

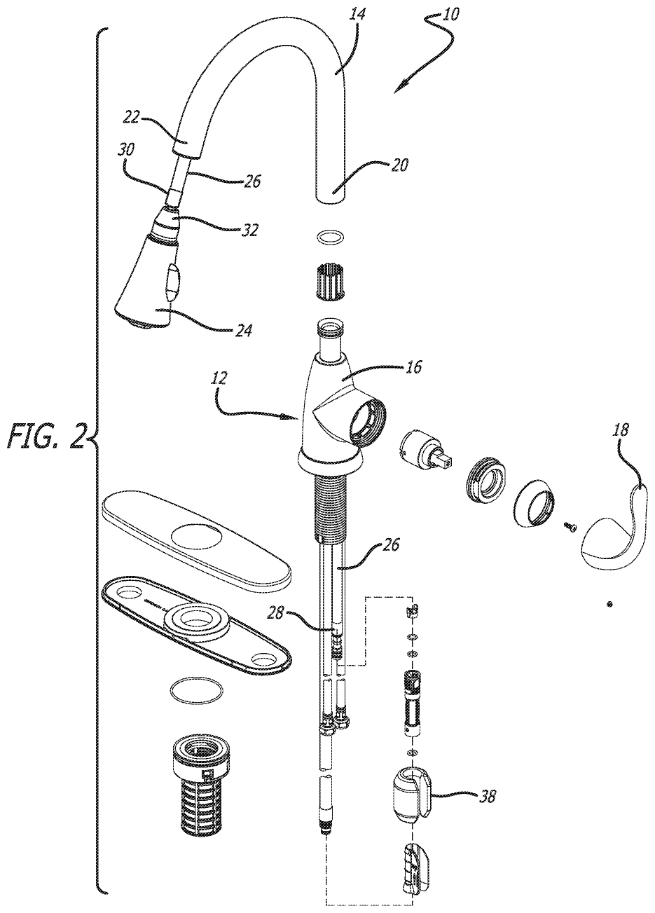

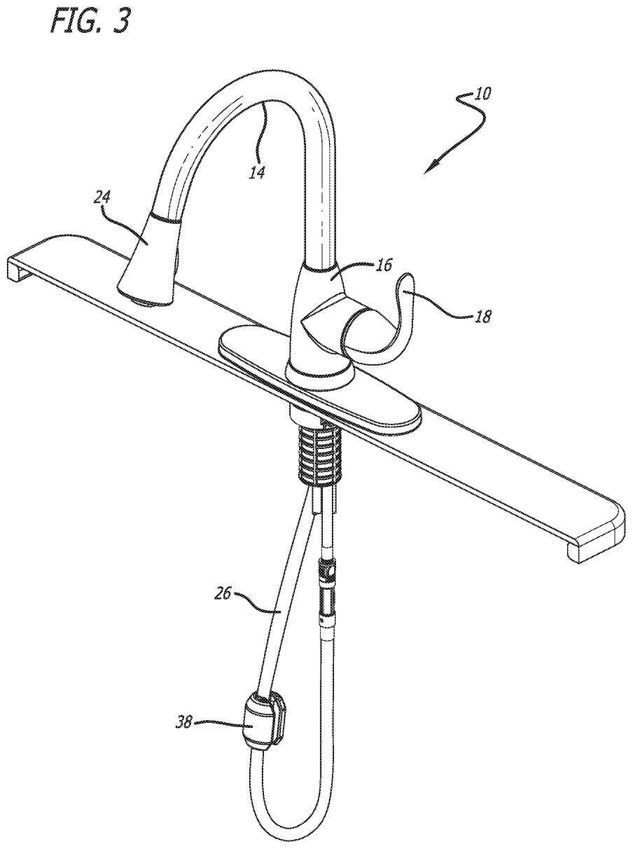

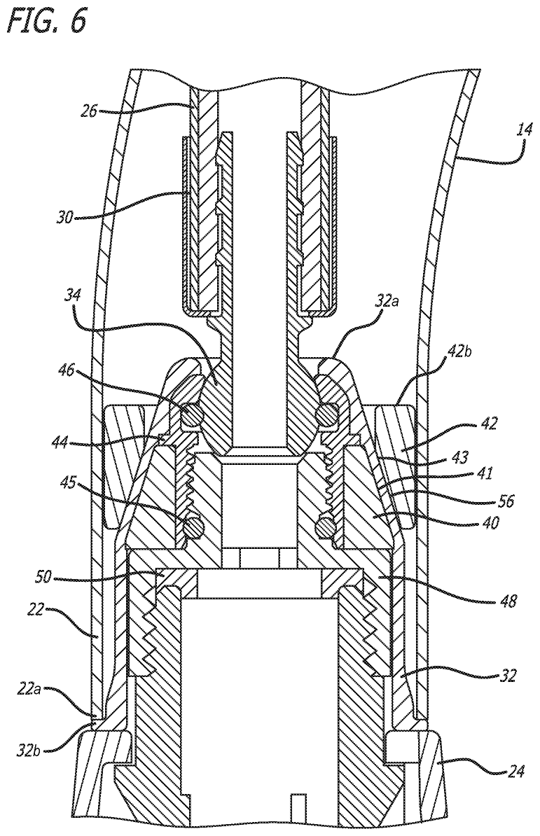

The sprayhead 24 of the faucet 10 is shown in FIGS. 1-3 and 5. The sprayhead 24 is releasably secured to the spout 14. Specifically, the sprayhead 24 is releasably secured to the discharge end 22 of the spout 14. In FIGS. 1 and 3, the sprayhead 24 is shown in its docked position, i.e., in a position in contact with the discharge end of the spout 14. In FIGS. 2 and 5, the sprayhead 24 is shown in its undocked position, i.e., in a position apart from the discharge end 22 of the spout 14.

Referring now to FIGS. 2, 3, 5-8 and 16, the faucet 10 includes a water hose 26. The water hose 26 is contained within the faucet 10, and is movable within that faucet 10. Water from the water source enters the water hose 26 at its inlet end 28 and leaves the water hose at its discharge end 30. The movement of the water hose 26 within the faucet 10 and its spout 14 is necessary, as that movement facilitates the positioning of the sprayhead 24 between its docked and undocked configurations.

As may also be seen in FIGS. 2, 5, 8-9, and 16, the faucet 10 also includes a spray hose connector 32. In this embodiment, the spray hose connector 32 has a shape similar to that of a bell.

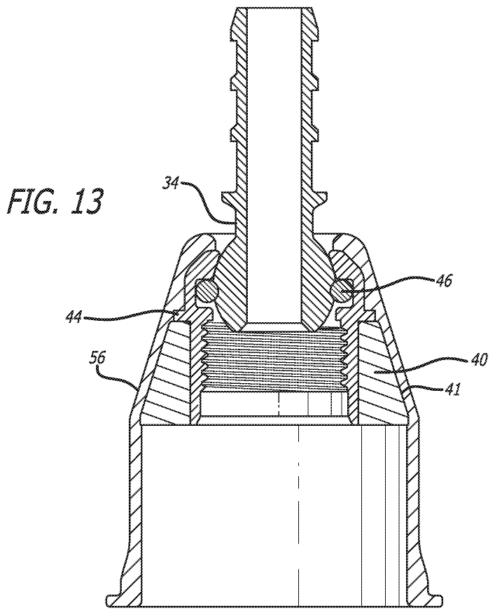

The spray hose connector 32 is attached to the discharge end 30 of the water hose 26. As may be seen in FIG. 9, the connection between the discharge end 30 of the water hose 26 and the spray hose connector 32 is effected by a ball joint 34. The ball joint 34 enables the spray hose connector 32 to swivel relative to the water hose 26. The spray hose connector 32 may be made of any suitable material. As will be explained later, the spray hose connector 32 may be made of a plastic (i.e., a polymer) that is formed by injection molding. A polymeric spray hose connector 32 that is made through injection over-molding can enable the capture of various components contained within that connector 32.

The spray hose connector 32 includes an inner connector 48 having internal threads. These internal threads of the inner connector 48 are complementary with the external threads 36 of sprayhead 24. The internal threads of the inner connector 48 engage the external threads 36 of the sprayhead 24 to connect the spray hose connector 32 to the sprayhead 24. When the spray hose connector 32 is threadably secured to the sprayhead 24, the water hose 26 and the spray hose connector 32 are in fluid communication with the sprayhead 24.

Again, sprayhead 24 is releasably attached to the water discharge end 22 of the spout 14. The sprayhead 24 is movable from a docked position (FIGS. 1 and 3), where it is secured to the discharge end 22 of the spout 14; to an undocked position (FIGS. 2 and 5), where it is moved away from that same discharge end 22 of the spout 14.

The sprayhead 24 is returned to, and retained in, its docked position by means of one or more components. Here, as may be seen in FIGS. 2 and 3, one component that may be used to return the sprayhead 24 to its docked position is a counterweight 38. The counterweight 38 is secured to the water hose 26.

Additional means for returning the sprayhead 24 to and retaining the sprayhead 24 in the docked position are magnetic attraction elements.

In this most preferred embodiment, the magnetic attraction elements comprise a magnet within the spray hose connector, and a metallic element within the spout. However, in practice these may be reversed, such that a magnet is secured to the spout, while the metallic element is secured to the interior of the spray hose connector. In addition, the magnetic attraction elements may be two magnets, one located within the spray hose connector and the other in the spout. The first magnet would have a first polarity and the second magnet would have a polarity opposite the first polarity.

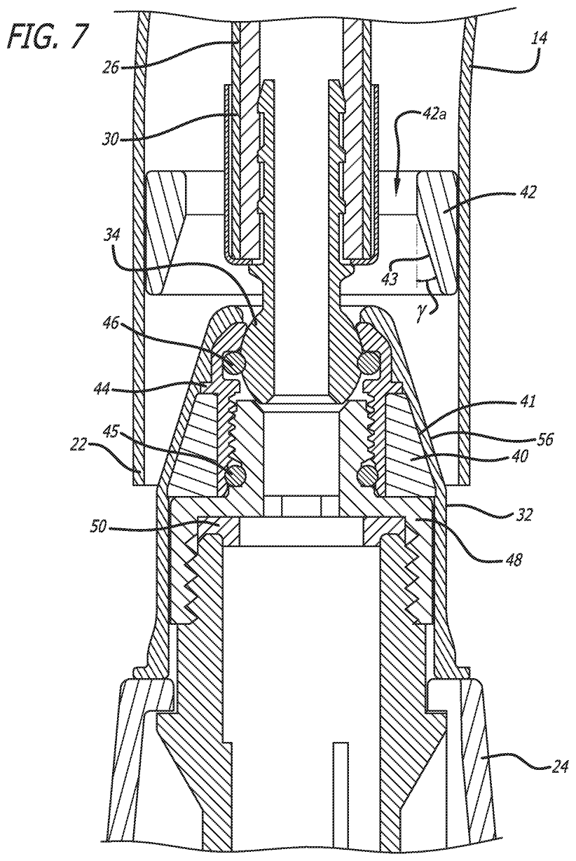

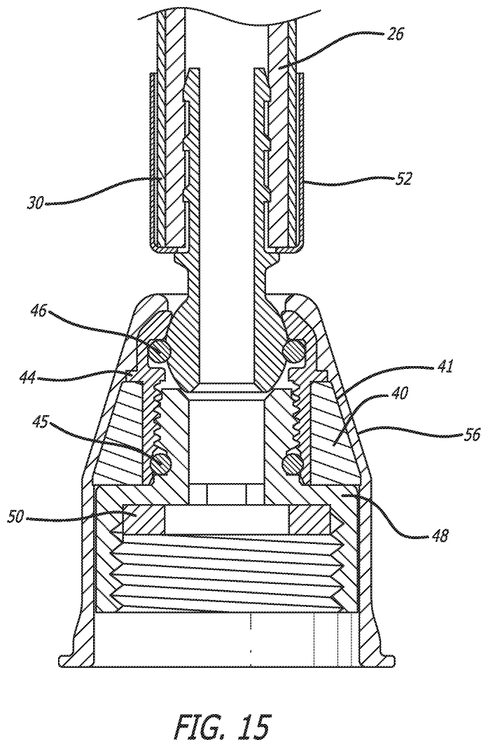

The magnet 40 may be best seen in FIGS. 6, 8, 9, 11, and 12-16. The magnet 40 in isolation is shown in FIG. 11. As may be seen in this FIG. 11, the magnet 40 has a frusto-conical shape, i.e., having the shape of a cone with the narrow end or tip removed. The magnet 40 is also annular, having a hollow center defining a central opening 40a, to allow the passage of fluid through it

The preferred magnet 40 is a N50 magnet, i.e., a neodymium N50 magnet. The specification/measured field of this preferred magnet is 4600 Gs. However, any suitable magnet may be used.

This magnet 40 is secured to the interior of the spray hose connector 32. This may best be seen in FIGS. 6, 12, and 16. The hollow, frusto-conical shaped magnet 40 essentially circumscribes the interior of the spray hose connector 32.

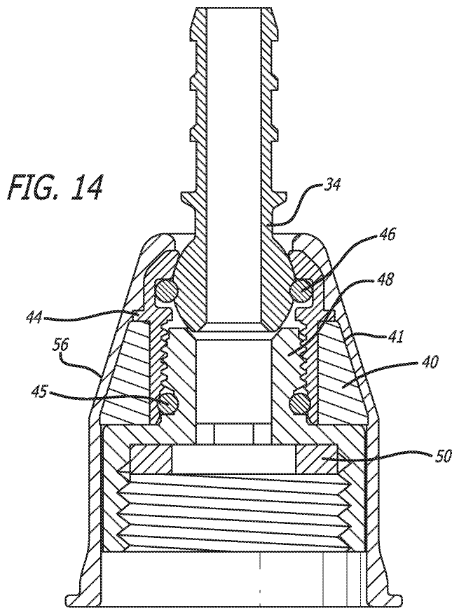

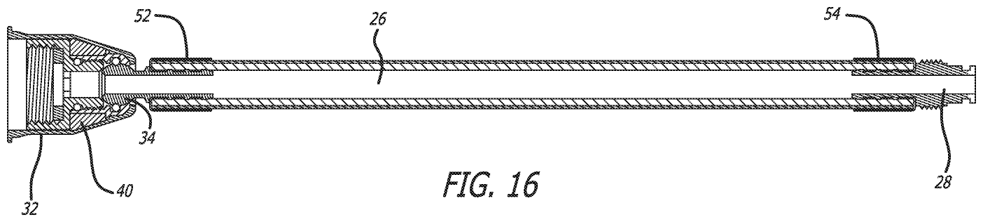

The magnet 40 may be held in place within the spray hose connector 24 by any suitable means. Here, however, as may be seen in FIGS. 10-12, the magnet 40 is loaded onto a brass machined joint piece 44. Then, as may be seen in FIG. 12, the shell of the spray hose connector 32 is formed by injection molding around the joint piece 44 and magnet 40. In this way, the shell of the spray hose connector 32 captures and retains in place the joint piece 44 and magnet 40.

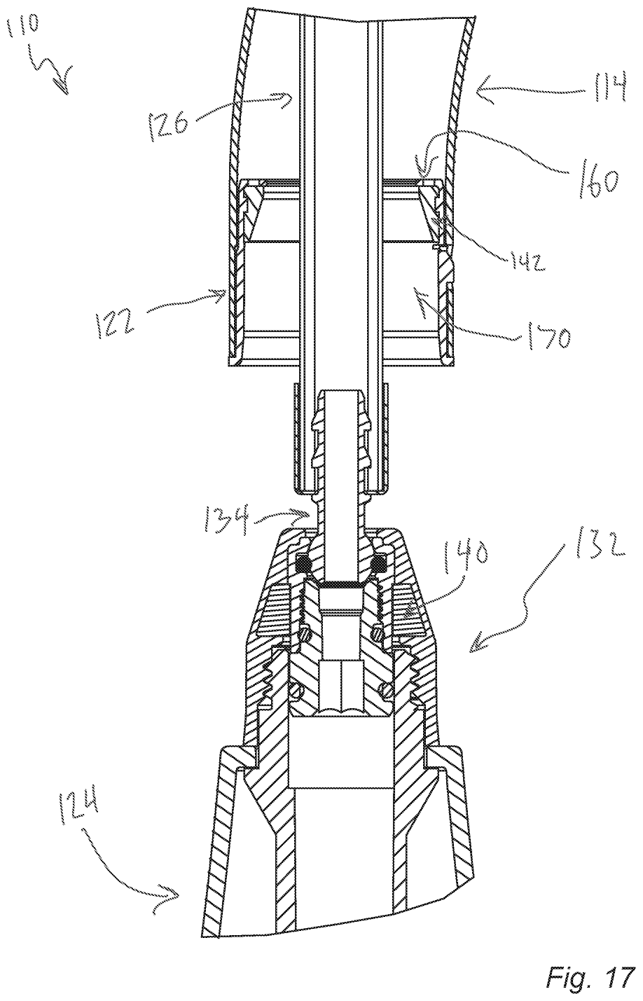

FIGS. 13-16 show additional assembly steps for the water hose 26, including its spray hose connector 32.

FIG. 13 shows the installation of the ball joint 34 and an O-ring 46.

FIG. 14 shows the addition of the inner connector 48, an O-ring 45, and a gasket 50. The inner connector 48 is threaded into the machined joint piece 44 following the injection molding process. The purpose of the inner connector 48 is twofold: (i) to assist in holding and securing the magnet 40 in its position; and (ii) to act as a connecting element for the sprayhead 24, whose external threads 36 are secured to the internal threads of the inner connector 48.

The purpose of gasket 50 is to provide a fluid-tight seal between the hose connector 32 and the sprayhead 24.

FIG. 15 shows the connection of the water hose 26 to a protective brass ring 52. The brass ring 52 is attached by riveting.

Finally, FIG. 16 shows the riveting of another connector 54 to the inlet end 28 of the water hose 26, to complete the process of forming this assembly.

As noted above, when the sprayhead 24 is in its docked position, it is positioned adjacent the discharge end 22 of the spout 14. As also noted above, positioned near the discharge end 22 of the spout 14 is a metallic element 42.

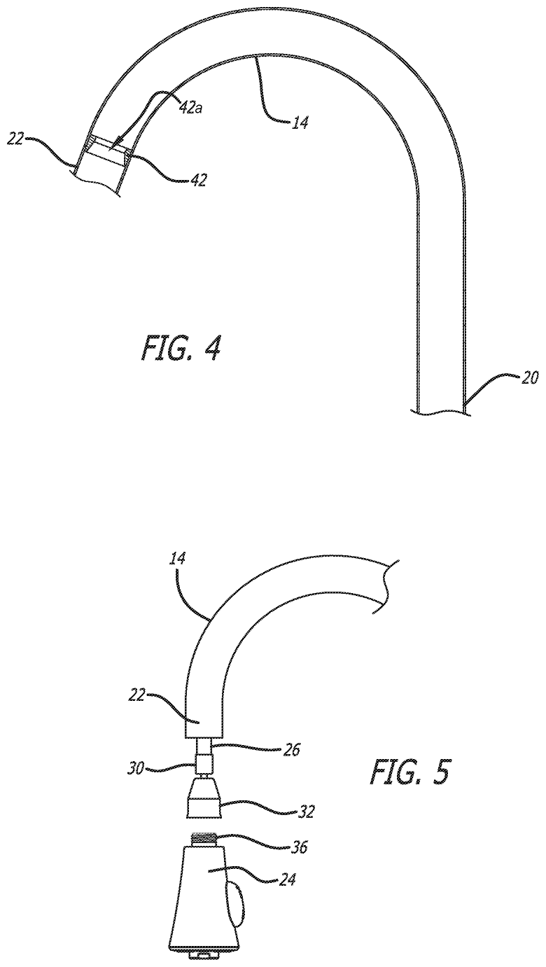

As may best be seen in FIG. 4, this metallic element 42 is contained within the interior of the spout 14. The exterior of this metallic element 42 has a conventional ring shape. In this way, as may be seen in FIG. 6, the exterior or outer walls of this metallic element 42 can fit snugly against the complementary round inner walls of the spout 14.

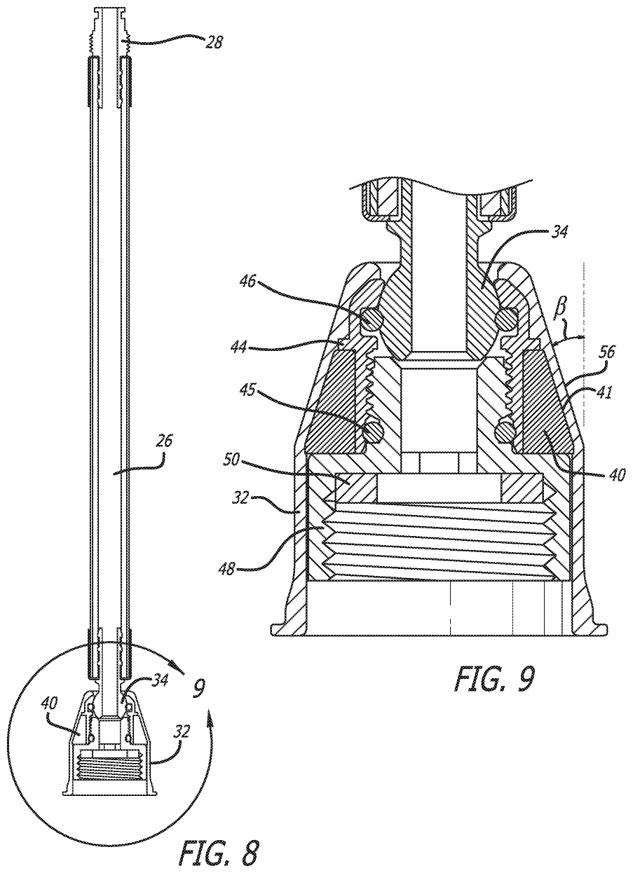

Referring to FIG. 4, the metallic element 42 is preferably hollow (i.e., annular) with a central opening 42a extending therethrough. As may be seen in FIG. 7, a portion of the inner walls 43 of the metallic element 42—that is, the lower portion of the inner wall 43 that forms or defines the hollow interior of the metallic element 42—create an inverted, hollow frusto-conical shape. By inverted, it is meant that the shape of the hollow portion at the lower end of the interior of the metallic element 42 is inverted, relative to the shape of the exterior of the frusto-conical magnet 40.

In this way, as installed, the shape of the angled inner walls 43 of the metallic element 42 complements the shape of the angled exterior walls 41 (FIGS. 7 and 11) of the magnet 40. As may be seen in FIG. 6, this complementary shape permits the exterior walls 41 of the magnet 40 and the inner walls 43 of the metallic element 42 to be in very close proximity to each other. In fact, as may also be seen in the docked position depicted in FIG. 6, the magnet 40 and metallic element 42 are separated from each other only be the thin angled outer wall of the spray hose connector 32. In FIG. 6, the spray hose connector 32 engages with the metallic element 42 in the docked position. As further shown in FIG. 6, a lower extent of the magnet 40 and/or exterior wall 56 of the spray hose connector 32 provides an outer diameter that is greater than an inner diameter of an intermediate portion of the central opening 42a of the metallic element 42 such that the magnet 40 is prevented from passing completely through the metallic element 42. Also in the docked position of FIG. 6, a top wall 32a of the spray hose connector 32 is positioned above and beyond a top wall 42b of the metallic element 42, while a lowermost flange 32b of the spray hose connector 32 resides against a lowermost end 22a of the discharge end 22 of the spout 14.

Referring again to FIG. 7 and especially FIG. 11, the exterior wall 41 of the magnet 40 has an angle α with the vertical of approximately 18°. Referring now to FIG. 9, the exterior wall 56 of the spray hose connector 32 has an angle β with the vertical of approximately 18°. Finally, referring to FIG. 7, inner walls 43 of the metallic element 42 have an angle γ with the vertical of approximately 18°. As a result of these angles and the thinness of the walls of the spray hose connector 32, there exists a closely adjacent relationship between the magnet 40 and the metallic element 42. This closely adjacent position of the magnet 40 and the metallic element 42 increases the magnetic forces between them, and results in a powerful magnetic attraction between them, as for example when the magnet 40 is approaching the metallic element 42 during the docking procedure. The three walls having the substantially identical angles α, β and γ as defined above are said have “complementary angles.”

While the embodiment shown in the Figures and described in this specification includes complementary angles of about 18°, the present disclosure is contemplated to include any suitable complementary angles. These complementary angles could range from 2° from the vertical to 50° from the vertical, with a preferred range of 2° to 25° from the vertical, and most preferred range of 15° to 21 ° from the vertical, as vertical is defined and depicted for each of the three angles described above.

While the magnet 40 and the metallic element 42 of the above preferred embodiment have the shapes and structures described above, it should be understood that the magnet 40 and the metallic element 42 could also both be of a conventional ring or frusto-conical shape; or that one of these two could be a ring, and the other one of these two could be frusto-conical.

The metallic element 42 can be made of any material that is magnetically attractive. In this preferred embodiment, however, the metallic element 42 is made of stainless steel, such as SUS 430 stainless steel. The metallic element 42 may be welded onto the interior walls of the spout 14.

As mentioned previously, it should also be understood that the magnetic attraction elements 40, 42 may also be two magnets, with one magnet having a first polarity and the second magnet having a polarity opposite the first.

The spout 14 may also be made of any suitable material. Non-limiting examples of a suitable material for the spout 14 are stainless steel or brass, although other materials could be used as well. In this preferred embodiment, the spout 14 is made of a SUS 201 stainless steel.

The sprayhead 24 is shown in its undocked position in FIGS. 2, 5, and 7. It is shown in its docked position in FIG. 6. The combination of the magnet 40 in the spray hose connector 32 with the metallic element 42 secured within the spout 14 results in a secure connection between the sprayhead 24 and the spout 14. In addition, when the undocked sprayhead 24 approaches the discharge end 22 of the spout 14, the magnetic force of the magnet 40 draws the sprayhead 24 towards spout 14 in a swift and powerful manner.

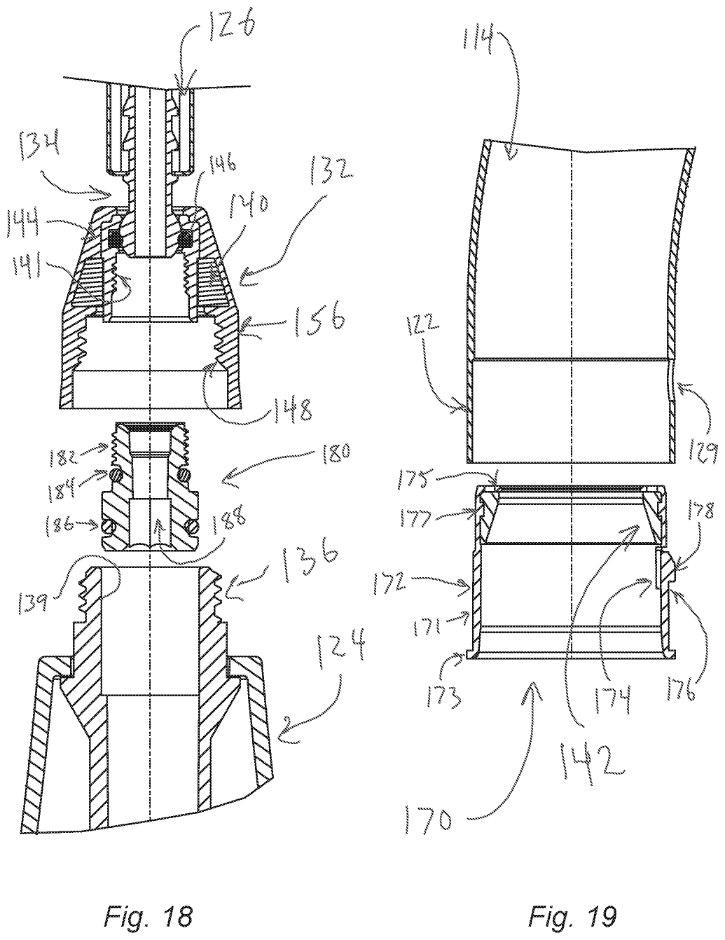

Another embodiment of a faucet 110 in accordance with the present disclosure is shown in FIGS. 17-21. The faucet 110 is similar to the faucet 10 shown in FIGS. 1-16, with similar reference numbers in the 100 series used to identify similar features to those of the faucet 10. The faucet 110 includes a body (not shown, but can be similar to the body 12 shown in FIGS. 1 and 2), a spout 114, and a sprayhead 124. The sprayhead 124 is movable relative to a discharge end 122 of the spout 114 between a docked position (FIG. 21) and an undocked position (e.g., FIG. 17).

In the illustrative embodiment, a magnetic docking system 160 of the faucet 110 includes a first magnetic attraction element 140 secured within a spray hose connector 132 coupled to the sprayhead 124 and a second magnetic attraction element 142 fixed to the discharge end 122 of the spout 114 by a holder 170 as shown in FIG. 17. In some embodiments, the first magnetic attraction element 140 is a magnet and the second magnetic attraction element 142 is a metallic element. However, in practice these may be reversed, such that a magnet is secured to the spout 114, while the metallic element is secured to the interior of the spray hose connector 132. In addition, the magnetic attraction elements 140, 142 may be two magnets, one located within the spray hose connector 132 and the other in the spout 114.

The spray hose connector 132 is attached to a water hose 126 by a ball joint 134 as shown in FIGS. 17 and 18. The spray hose connector 132 includes an exterior wall 156 and inner threads 148 complementary with external threads 136 of sprayhead 124 as shown in FIG. 18. The internal threads 148 of the spray hose connector 132 engage the external threads 136 of the sprayhead 124 to connect the spray hose connector 132 to the sprayhead 124. When the spray hose connector 132 is threadably secured to the sprayhead 124, the water hose 126 and the spray hose connector 132 are in fluid communication with the sprayhead 124.

A joint piece 144 is mounted in the spray hose connector 132 and engages with the ball joint 134 to hold the spray hose connector 132 on the water hose 126 as shown in FIG. 18. A seal member 146 (such as an O-ring) engages with the joint piece 144 and ball joint 134 to provide a seal. Inner threads 141 of the joint piece 144 are complementary with external threads 182 of a plug 180. The internal threads 141 of the joint piece 144 engage the external threads 182 of the plug 180 to connect the plug 180 to the spray hose connector 132. A seal member 184 (such as an O-ring) engages with the joint piece 144 and plug 180 to provide a seal. The plug 180 extends into the sprayhead 124, and a seal member 186 (such as an O-ring) engages with the plug 180 and an inner surface 139 of the sprayhead 124 to provide a seal. A passage 188 of the plug 180 allows water to flow form the water hose 126 to the sprayhead 124.

In the illustrative embodiment, the holder 170 includes a sleeve 172 and a clip 174 coupled to the sleeve 172 as shown in FIG. 19. The sleeve 172 includes a perimeter wall 171, a base wall 173 arranged at one end of the perimeter wall 171, and a top wall 175 arranged at an opposite end of the perimeter wall 171 from the base wall 173. The second magnetic attraction element 142 is arranged adjacent to the top wall 175 and inside of the perimeter wall 171. In some embodiments, a flange 177 extends from the perimeter wall 171 toward the second magnetic attraction element 142 to fix the second magnetic attraction element 142 relative to the sleeve 172. In some embodiments, the holder 170 is injection molded around the second magnetic attraction element 142. The clip 174 includes a flexible tab 176 coupled to the perimeter wall 171 and a finger 178 extending from the flexible tab 176. The holder 170 is inserted into the spout 114 until the base wall 173 engages with the discharge end 122. The flexible tab 176 allows the finger 178 to move inward during insertion of the holder 170, and the flexible tab 176 forces the finger 178 outward to extend into a hole 129 in the spout 114 to fix the holder 170 relative to the spout 114.

A user inserts the spray hose connector 132 into the spout 114 to position the magnetic attraction elements 140, 142 adjacent to one another as shown in FIG. 20. A magnetic attraction force between the magnetic attraction elements 140, 142 pulls the sprayhead 124 toward the spout 114 into the docked position as shown in FIG. 21. A user pulls the sprayhead 124 against the magnetic attraction force between the magnetic attraction elements 140, 142 to move the sprayhead 124 away from the spout 114 to an undocked position (e.g., FIG. 17).

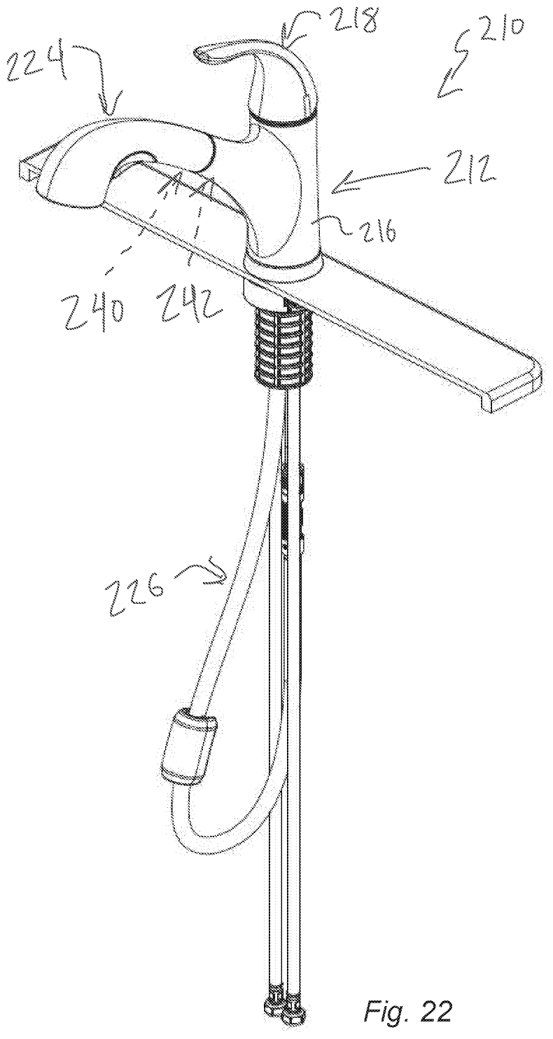

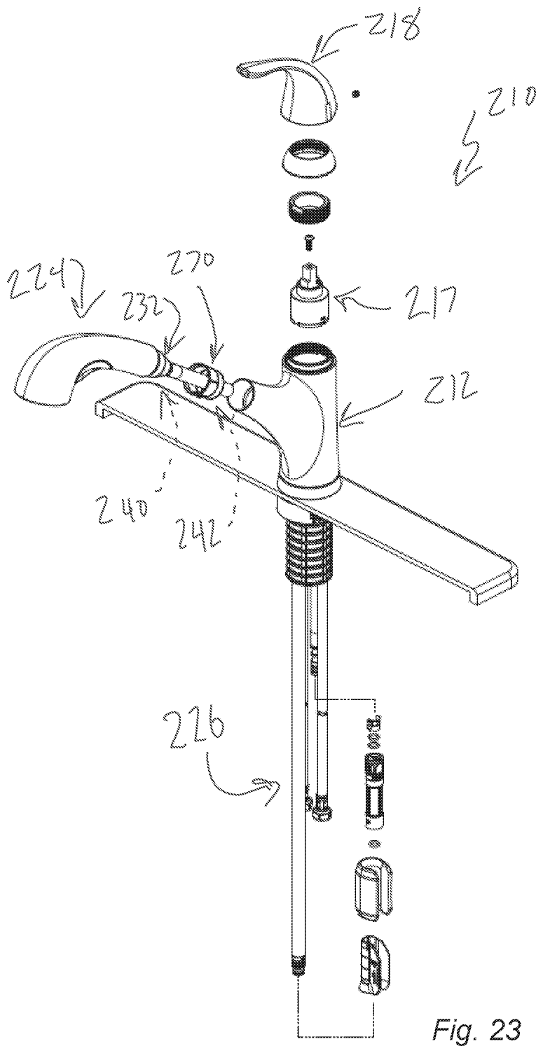

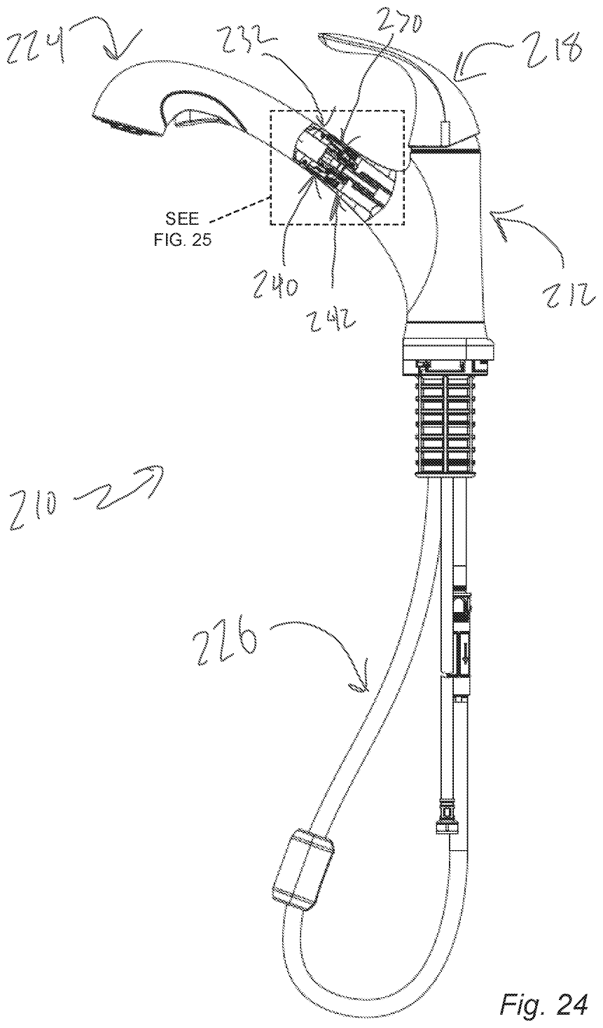

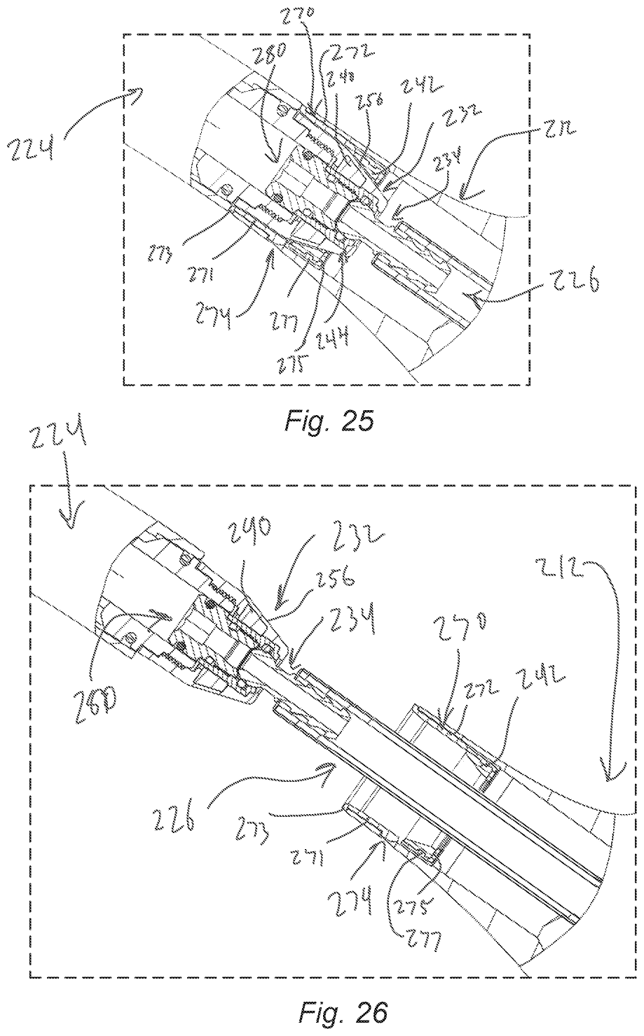

Another embodiment of a faucet 210 in accordance with the present disclosure is shown in FIGS. 23-26. The faucet 210 is similar to the faucets 10 and 110 shown in FIGS. 1-21, with similar reference numbers in the 200 series used to identify similar features to those of the faucets 10, 110. The pull-out faucet 210 includes a water nozzle or body 212, a pull-out head or sprayhead 224, a first magnetic member 242 and a second magnetic member 240. A pull-out conduit or water hose 226 is received in the water nozzle, while the pull-out head 224 is engaged in an extractable way with the water nozzle 212 by a connecting assembly or spray hose connector 232 disposed at one end of the pull-out head. The pull-out conduit 226 is detachably connected to the connecting assembly comprising a containment housing or exterior wall 256. The first magnetic member 242 is secured to the water nozzle 212 by an outer bushing or holder 170 which is integrated with the first magnetic member by means of a secondary molding process. The second magnetic member 240 is embedded in the containment housing 256 of the connecting assembly 232, and the containment housing 256 and the second magnetic member 240 are molded as integrated component by a secondary molding process. The first magnetic member 242 and the second magnetic member 240 are separated from each other by the containment housing 256. The second magnetic member 240 is configured and arranged to be opposite to at least a portion of the first magnetic member 242, thereby promoting a restoration of the pull-out head 224 by a generated magnetic effect.

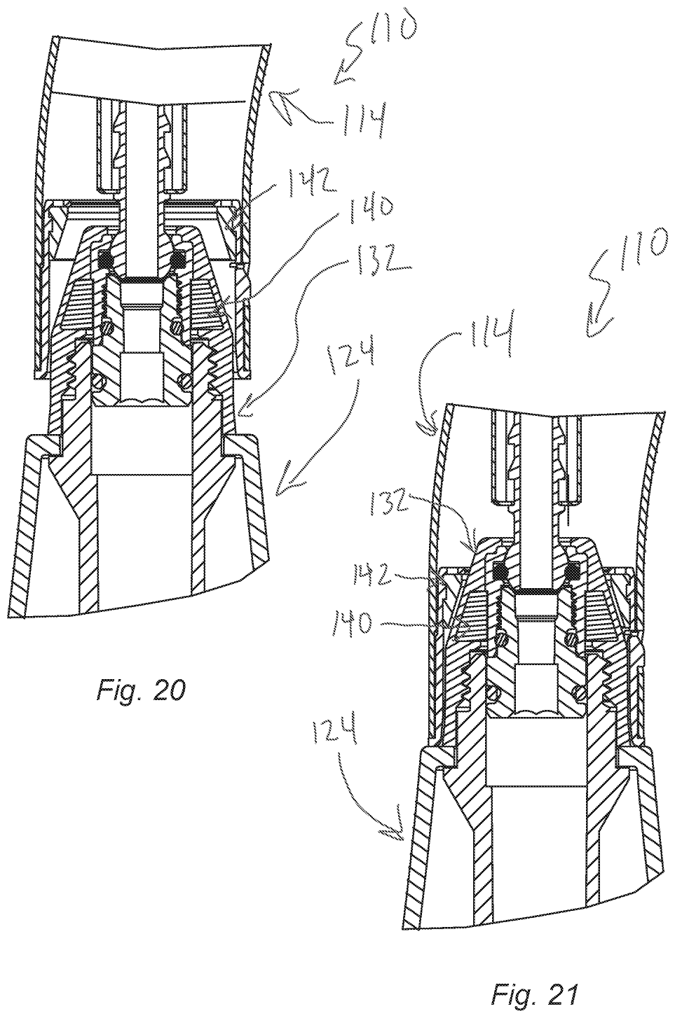

A magnetic attraction of the two magnetic members makes the pull-out head 224 reach to a predetermined position quickly and stably when the pull-out head restores, which ensures an effective restoration of the pull-out head 224 and avoids any possible restoration deviation as suggested in FIGS. 22-26. The two magnetic members are separated by the containment housing 256 in order to avoid any impact between the two magnetic members during the restoration of the pull-out head 224, thereby prolonging the service life of these two magnetic members. In some other faucets, a magnetic member is secured by welding to a water nozzle, and during the restoration process of a pull-out head, it occurs that a small quantity of liquid is returned back towards the water nozzle leading to rusting, possibly rust water, which easily appears at the welding between the magnetic member and the water nozzle in such a humid state for a long period of time. During the process that the pull-out conduit is extracted out of the water nozzle in these other faucets, it is possible that rust water is adhered to the surface of the pull-out conduit, and thus a part of rust water is possibly taken out of the water nozzle, resulting in poor user experience in operation, and more possibly, the rusting can lead to the separation of magnetic members from the water nozzle, which influences the exact and effective restoration of the pull-out head.

According to the present disclosure, the outer bushing 270 is integrated with the first magnetic member 242 by means of a secondary molding process as shown in FIGS. 23-26. Also, the containment housing 256 is integrated with the second magnetic member 240 by means of a secondary molding process. The secondary molding process has advantages of simple process, lower process accuracy requirements than that of the machining, and easier industrialized production. The molded outer bushing 270 is combined with the first magnetic member 242 to form an integrated component by putting the first magnetic member 242 into the respective mould into which the respective molding material is then added, which facilitates the positioning, assembly and replacement of the first magnetic member 242, and improves user experience of operating the pull-out faucet 210.

The outer bushing 270 is configured in an annular shape and comprises an engagement part or clip 274, while an engagement hole 229 is provided on a side wall of the water nozzle 212 as shown in FIGS. 23-26. The engagement part 274 is engaged with the engagement hole 229 so as to secure the outer bushing 270 to the water nozzle 212. In this embodiment, the engagement part 274 is configured as suspension arm provided on the periphery of the outer bushing 270. The suspension arm extends in an axial direction of the outer bushing 270 and has a snap connector extending in a radial direction. When the outer bushing 270 is placed into the water nozzle 212, the suspension arm can be pressed, and after the snap connector is entered into the engagement hole 229, the pressed suspension arm restores to its initial shape, such that the outer bushing 270 equipped with the first magnetic member 242 is secured to the water nozzle 212. In this application, the pull-out faucet 210 also comprises a mounting seat or base portion 216 which together with the water nozzle 212 is configured as an integrated Tee-shaped structure, wherein the water nozzle 212 is deviated from the axis of the mounting seat 216 and extended in the radial direction. A valve cartridge 217 used for controlling the switching on/off of the fluid is received in the mounting seat 216. A handle 218 is positioned above the mounting seat 216 and can drive a valve stem of the valve cartridge 217 so as to control the on-off of the valve cartridge 217.

Although the outer bushing 270 and the water nozzle 212 are snapped with each other as shown in FIGS. 23-26, other engagements are contemplated by the present disclosure, such as threading on the outer peripheral surface of the outer bushing 270 and on the inner peripheral surface of the water nozzle 212, so that the outer bushing 270 and the water nozzle 212 can be secured together by a threaded connection. Furthermore, adhesion is also suitable to secure the outer bushing 270 to the water nozzle 212.

The outer bushing 270 further comprises an extension portion or base wall 273 extending in the radial direction of the outer bushing 270 to cover an edge of the water nozzle 212, so that after the pull-out head 224 is entered in the water nozzle 212 under the magnetic effect, the extension portion 273 can prevent a direct impact of the pull-out head 224 with the water nozzle 212, mitigating wear of the pull-out head 224 and the water nozzle 212 as shown in FIGS. 23-26.

In addition, the connecting assembly 232 further comprises an inner bushing or joint piece 244 and an inner sleeve or plug 280 as shown in FIGS. 23-26. The inner bushing 244 is provided in the containment housing 256, and at one end thereof is engaged with the inner sleeve 280 and at the other end is configured with a recess. A connecting head or ball joint 234 located at an end of the pull-out conduit 226 is received in the recess, and a portion of the recess in connection to the connecting head 234 is configured to conform to the connecting head 234. The end of the pull-out head 224 facing to the water nozzle 212 is provided with a connecting part which is received between the inner sleeve 280 and the containment housing 256 and detachably connected to the containment housing 256. The connecting head 234 is configured in a spherical shape and provided in its interior with a flowing-through channel in communication with the pull-out conduit 226. The inner sleeve 280 has a flow channel therethrough to communicate with the flow channel of the connecting head 234. By means of the engagement (such as, hinge joint) of the connecting head 234 and the recess of the connecting assembly 232 (in particular, the inner bushing 244), the pull-out head 224 can be connected with the pull-out conduit 226 and can drive the pull-out conduit 226 so as to achieve pull-out operation. In this embodiment, the connecting head 234 can rotate in all directions (i.e., a free rotation in three-dimensional space) relative to the connecting assembly 232 in order to meet the requirement of converting the spray angle of the pull-out head 224. Fluid can flow out of the pull-out conduit 226 through the flow channel of the connecting head 234 therethrough after being supplied to pull-out conduit 226, then flow through the flow channel located in the inner sleeve 280 of the connecting assembly 232 to the pull-out head 224, and subsequently flow/spray from an outlet of the pull-out head 224 to supply to users. In this embodiment, the connecting head 234 is preferably configured as ball head and the recess is configured as a ball socket. The ball head and the ball socket can be connected with each other by hinge joint, so as to achieve the connection of the pull-out conduit 226 with the connecting assembly 232. Moreover, other forms of connection between the connecting assembly 232 and conduit 226 are contemplated by the present disclosure.

A seal is provided in the recess of the inner bushing 244, such as, an O-ring, as shown in FIGS. 23-26. The inner sleeve 280 and the inner bushing 244 can be detachably connected by thread connection. Other seals are also disposed between the inner sleeve 280 and the inner bushing 244. Further, a seal is provided between the inner sleeve 280 and the connecting part of the pull-out head 224.

In some embodiments, the containment housing 256 is configured to be tapered downwardly in the axial direction of the pull-out conduit 226, that is, the diameter of the containment housing 256 decreases gradually as shown in FIGS. 23-26. In the engagement state of the pull-out head 224 and the water nozzle 212, the containment housing 256 is received in the water nozzle 212, wherein the first magnetic member 242 is configured to conform to the tapered structure of the containment housing 256, so that after the engagement of the pull-out head 224 and the water nozzle 212, the first magnetic member 242 and the opposite surface of the second magnetic member 240 are generally parallel to each other, and therefore the maximum coincident area of the magnetic interaction surface is achieved, which facilitates a rapid and exact restoration of the pull-out head 224.

In addition, a notch is provided on the periphery surface of the first magnetic member 242 and configured to such that the outer bushing 270 formed by a secondary molding process has a matched protrusion or flange 277, so that the first magnetic member 242 and the outer bushing 270 can be stably joined together to form an integrated component as shown in FIGS. 23-26. The notch can be provided on the side of the first magnetic member 242, and can have a circle, ellipse or trapezoid shape, while it is not limited by the shown square shape. After the matched outer bushing 270 is formed integrally with the first magnetic member 242 by means of a secondary molding process, the outer bushing 270 is used to position the first magnetic member 242 by the engagement the formed protrusion 277 with the notch of the first magnetic member 242, so that the first magnetic member 242 and the outer bushing 270 can be stably joined.

Further, the outer bushing 270 also has a bearing part or top wall 275 and a detent part or perimeter wall 271 as shown in FIGS. 23-26. The bearing part extends radially inwardly from the outer bushing and it is configured to support the first magnetic member 242. The detent part is disposed at an end of the bearing part and generally extends towards the pull-out head 224 parallely to the bearing part so as to define a space receiving the first magnetic member 242 relative to the inner periphery surface of the outer bushing 270, which facilitates the stable connection of the first magnetic member 242 and the outer bushing 270, for example, by means of a secondary molding process. On the basis of the above-mentioned structures, other structures which facilitate the integrated connection of the first magnetic member 242 and the outer bushing 270 and positioning of the first magnetic member 242 and their improvements also fall within the scope of the present disclosure.

Additionally, in the axial section of the second magnetic member 240, it can be seen that the second magnetic member 240 is tapered towards the pull-out conduit 226 and the outer wall of the second magnetic member 240 has included an angle in a range of from about 2° to about 50°, preferably about 18°, with respect to the axis of the containment housing 256. In some embodiments, the outer periphery surface of the second magnetic member 240 can be configured as a curved surface.

In some embodiments, the adopted first magnetic member 242 can be formed from a magnetic material such as stainless steel which is integrated with the outer bushing 270 by a secondary molding process, while the adopted second magnetic member 240 can be formed from a magnetic body such as magnetic-iron which is integrated with the containment housing 256 by a secondary molding process. The positions of the two magnetic members are interchangeable relative to each other. In general, the magnetic body can be an N50 magnet, but other magnets are also contemplated by the present disclosure.

What is claimed is:

1. A pull-down faucet with magnetic docking capability, the pull-down faucet comprising:
(a) a spout having an internal first magnetic attraction element secured near a discharge end of the spout with a holder, the holder engaged between the first magnetic attraction element and the spout, the first magnetic attraction element having a central opening;
(b) a water hose extending into the spout and movable through the internal first magnetic attraction element and the discharge end of the spout;
(c) a spray hose connector coupled to the water hose and having an exterior wall that radially surrounds an internal second magnetic attraction element;
(d) a sprayhead coupled to the spray hose connector and in fluid communication with the water hose;
wherein the sprayhead and spray hose connector are movable between (i) a docked position where the sprayhead and the spray hose connector are joined to the discharge end of the spout by a magnetic attraction force provided by the first and second magnetic attraction elements, and (ii) an undocked position where the sprayhead and the spray hose connector are spaced a distance from the discharge end of the spout; and
wherein in the docked position, the exterior wall of the spray hose connector is positioned between the first magnetic attraction element and the second magnetic attraction element.

2. The pull-down faucet of claim 1, wherein the first magnetic attraction element has an angled inner surface, the second magnetic attraction element has an angled outer surface, and the exterior wall of the spray hose connector has an angled portion, and
wherein the angled inner surface of the first magnetic attraction element, the angled outer surface of the second magnetic attraction element and the angled portion of the exterior wall of the spray hose connector have a substantially common complementary angle as defined relative to a central axis that extends through the spray hose connector and the first and second magnetic attraction elements in the docked position.

3. The pull-down faucet of claim 2, wherein the common complementary angle ranges from about 2° to about 50°.

4. The pull-down faucet of claim 1, wherein the spray hose connector further includes a joint piece, wherein the second magnetic attraction element is radially positioned between the joint piece and the exterior wall of the spray hose connector.

5. The pull-down faucet of claim 4, wherein the exterior wall of the spray hose connector is injection molded over the joint piece and the first magnetic attraction element.

6. The pull-down faucet of claim 4, further comprising a ball joint coupled to both the water hose and the joint piece to operably connect the spray hose connector with the water hose.

7. The pull-down faucet of claim 6, wherein in the docked position, an upper portion of the ball joint is located above and beyond the first magnetic attraction element and a lower portion of the ball joint is coincident with and not beyond the first magnetic attraction element.

8. The pull-down faucet of claim 6, the spray hose connector further including an inner connector coupled to the ball joint by the joint piece, wherein the inner connector is adapted to be coupled to the sprayhead.

9. The pull-down faucet of claim 1, wherein the exterior wall of the spray hose connector has an upper end wall and an angled portion depending from the upper end wall, and wherein in the docked position, the upper end wall of the spray hose connector is positioned above the first magnetic attraction element and the angled portion engages the first magnetic attraction element.

10. The pull-down faucet of claim 1, wherein in the docked position, an extent of the spray hose connector extends into the central opening of the first magnetic attraction element whereby the spray hose connector engages the first magnetic attraction element, said engagement preventing the second magnetic attraction element from passing through the central opening of the first magnetic attraction element.

11. The pull-down faucet of claim 1, wherein in the docked position, an extent of the spray hose connector extends into the central opening of the first magnetic attraction element whereby the spray hose connector engages the first magnetic attraction element, said engagement preventing the spray hose connector, in its entirety, from passing through the central opening of the first magnetic attraction element.

12. The pull-down faucet of claim 1, wherein the holder includes a sleeve and a clip, wherein the sleeve extends into the spout and the clip engages with a hole in the spout to fix the holder relative to the spout.

13. The pull-down faucet of claim 12, wherein the sleeve include a perimeter wall, a base wall arranged at one end of the perimeter wall, and a top wall arranged at an opposite end of the perimeter wall from the base wall, and wherein the second magnetic attraction element is arranged adjacent to the top wall and inside of the perimeter wall.

14. The pull-down faucet of claim 13, wherein a flange extends from the perimeter wall toward the second magnetic attraction element to fix the second magnetic attraction element relative to the sleeve.

15. The pull-down faucet of claim 13, wherein the clip includes a flexible tab coupled to the perimeter wall and a finger extending from the flexible tab, wherein the flexible tab is configured to allow the finger to move inward with insertion of the holder into the spout and to force the finger into the hole in the spout.

16. The pull-down faucet of claim 1, wherein the holder is injection molded around the second magnetic attraction element.
